(19) United States
(12) Patent Application Publication
(10) Pub. No.: US 2009/0094426 A1
(43) Pub. Date: Apr. 9, 2009

(54) STORAGE SYSTEM

(76) Inventors: Hirokazu IKEDA, Yamato (JP); Nobuhiro Maki, Yokohama (JP); Nobuyuki Osaki, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/017,725

(22) Filed: Jan. 22, 2008

(30) Foreign Application Priority Data
Oct. 5, 2007 (JP) 2007-262675

(51) Int. Cl. G06F 12/16

(52) U.S. Cl. 711/162; 711/E12.103

(57) ABSTRACT

An object of the present invention is to reduce the required volume capacity and journal control resources by sharing the journal volumes of an asynchronous copy function and a CDP function.

In a configuration where an asynchronous copy function and a CDP function share a journal volume, when the journal volume is updated, only the journal data provided to both a volume at remote locations and a base volume is set to be a target for deletion or overwriting.

### CROSS-REFERENCES TO RELATED APPLICATIONS

This application relates to and claims priority from Japanese Patent Application No. 2007-262675, filed on Oct. 5, 2007, the entire disclosure of which is incorporated herein by reference.

### BACKGROUND

### Field of the Invention

The invention relates to a storage system, and it is particularly suitable for application in the management of a data replication technique in a storage system.

Because of the widespread use of computers, the size of data dealt with in the computers is growing each year. A storage apparatus is an apparatus for keeping a large volume of data safely and efficiently; and is connected to computers via communication lines so that it provides a volume (a container for data). If a computer system including a storage system stops because of an unexpected trouble or a disaster, etc., it can have serious effects on businesses.

DR (disaster recovery) indicates taking over and carrying on operations at remote locations even if a computer system stops, or that kind of technique in general. As an element technique for achieving this, a remote-copying is known.

Remote-copying is a technique for holding a copy of data in a storage array at remote locations, and has two systems: a synchronous system and an asynchronous system. The synchronous system ensures an exact match to data at remote locations, but the more it ensures an exact match, the more performance overhead for writing increases, so distance limitations exist in practice. On the other hand, the asynchronous system is practical even over long distances because it does not have writing overhead; however, it cannot ensure an exact match to the latest data. In the asynchronous system, update data for sending to and receiving from remote locations is referred to as a journal; and a journal volume is often used as a place to hold the journal temporarily. When a journal is reflected in volumes at remote locations, the previously reflected journal is allowed to be deleted or overwritten so the capacity of the journal volume is not exceeded. Hereinafter, the asynchronous system is referred to as an asynchronous copy technique or asynchronous copy function.

In cases when data is inaccessible because of an error or misoperation in business applications or a virus infection, etc. as well as the failure of a storage array as described above, the storage array has a function to create the backup of a volume, which is a unit of data storage. The backup is created at a given point in time; and after a failure, data can be rebuilt using the previously created backup. CDP (Continuous Data Protection) indicates a technique capable of rebuilding data post-failure at a given point in time by keeping a backup of update data each time data is written, as a journal in chronological order.

JP2005-222110 A discloses a technique to implement CDP in a storage array at a remote location. As an example of CDP, an implementation method is known wherein data at a specified point in time in the past is held as a base volume; update data (a journal) is arbitrarily provided to the base volume and data at a given point in time is thereby rebuilt. In that situation, journals retained beyond a predetermined data retention period are provided to the base volume one after another, and the provided journals are allowed to be deleted or overwritten so that the capacity of the journal volume is not exceeded (see JP2005-222110 A).

### SUMMARY

As a configuration associated with DR, copy creation for remote locations using an asynchronous copy function, and a CDP function for recovery to a given point in time, are different in use; however, are both highly necessary. Therefore, they are normally used at the same time. In that case, in the conventional technique, the asynchronous copy function and the CDP respectively need a journal volume, and they both hold update data, so the problem of using the capacity of volumes and a journal control resource inefficient may arise. However, if they simply use the same journal, the asynchronous copy function deletes unnecessary journal data that has already been copied to remote locations one after another, so data during the data retention period in the CDP may be lost. Or otherwise, data may be lost, even though the data has not yet been copied by the asynchronous copy function, because the journal data retained beyond the data retention period in the CDP, is considered as unnecessary data.

The current invention has been devised in consideration of the above-described points, and it is an object of the present invention to provide a storage system capable of reducing volumes used by storage arrays and reducing computational resources for controlling journals.

In the invention, with a configuration where an asynchronous copy function and a CDP function share a journal volume, when the journal volume is updated, only the journal data, which is provided to both a volume at a remote location and a base volume, is set to be a target for deletion or overwriting.

With respect to data using both the asynchronous copy function and the CDP function, the asynchronous copy function and the CDP function share the journal volume, so the number of volumes used by a storage system and computational resources for controlling journals can be reduced.

According to an aspect of the invention, a storage system including a first storage system connected to a host via a communication channel, and a second storage system connected to the first storage system via a communication channel, is provided with: a first data volume for writing data sent from the host, wherein the first data volume is included in the first storage system; a first journal volume for writing the data stored in the first data volume as journal data, identifiable and in chronological order, wherein the first journal volume is included in the first storage system; a second data volume keeping previous data, wherein the second data volume is included in the first storage system; a first storage controller that recovers the first data volume by providing the journal data to the second data volume; a second journal volume for storing the journal data of the first journal volume in the second storage system, wherein the second journal volume is included in the second storage system; a third data volume that is a replica of the first data volume, wherein the third data volume is included in the second storage system; a second storage controller retrieving the journal data from the first journal volume, providing the journal data of the second journal volume to the third data volume, thereby synchronizing the data with data of the first data volume; and a third storage controller designating, from among the journal data stored in the first journal volume, the journal data provided to both the second data volume and the third data volume as a target for deletion or overwriting.

Also, according to an aspect of the invention, a storage system including a first storage system and a second storage system is provided with: a first data volume for writing data sent from a host, wherein the first data volume is included in the first storage system; a first journal volume for writing the data stored in the first data volume as journal data, identifiable and in chronological order, wherein the first journal volume is included in the first storage system; a second journal volume for storing the journal data of the first journal volume, wherein the second journal volume is included in the second storage system; a second data volume which is a replica of the first data volume, wherein the second data volume is included in the second storage system; a first storage controller retrieving the journal data from the first journal volume, providing the journal data of the second journal volume to the second data volume, thereby synchronizing data with data of the first data volume; a third data volume keeping previous data, wherein the third data volume is included in the second storage system; a second storage controller that recovers the first data volume by providing the journal data of the second journal volume to the third data volume; and a third storage controller designating, from among the journal data stored in the second journal volume, the journal data provided to both the second data volume and the third data volume as a target for deletion or overwriting.

Furthermore, according to an aspect of the invention, a storage system including a first storage system connected to a host via a communication channel, and a second storage system connected to the first storage system via a communication channel, is provided with: a first data volume for writing data sent from the host, wherein the first data volume is included in the first storage system; a first journal volume for writing the data stored in the first data volume as journal data, identifiable and in chronological order, wherein the first journal volume is included in the first storage system; a second data volume keeping previous data in the first storage system, wherein the second data volume is included in the first storage system; a first storage controller that recovers the first data volume by providing the journal data to the second data volume; a second journal volume for storing the journal data of the first journal volume in the second storage system, wherein the second journal volume is included in the second storage system; a third data volume which is a replica of the first data volume, wherein the third data volume is included in the second storage system; a second storage controller retrieving the journal data from the first journal volume, providing the journal data of the second journal volume to the third data volume, thereby synchronizing the data with data of the first data volume; a fourth data volume keeping previous data in the second storage system, wherein the fourth data volume is included in the second storage system; a third storage controller that recovers the first data volume by providing the journal data of the second journal volume to the fourth data volume; and a fourth storage controller designating, from among the journal data stored in the first journal volume, the journal data that is provided to all the second data volume, the third data volume and the fourth data volume as a target for deletion or overwriting.

According to the invention, it is possible to provide a storage system capable of reducing volumes used by storage arrays and computational resources for controlling journals.

Other aspects and advantages of the invention will be apparent from the following description and the appended claims.

### BRIEF DESCRIPTION OF THE DRAWINGS

FIG. 1 is a diagram showing an example of the configuration of a storage system including a computer according to the first embodiment of the present invention.

FIG. 2 is a diagram showing an example of the configuration of a storage array at a local end according to the first embodiment of the present invention.

FIG. 3 is a diagram showing an example of the configuration of a storage array at a remote end according to the first embodiment of the present invention.

FIG. 4 is a diagram showing an example of the configuration of a volume within a storage array according to the first embodiment of the present invention.

FIG. 5 is a diagram showing a configuration example of journal data within a journal data volume according to the first embodiment of the present invention.

FIG. 6 is an example of a table for managing the configuration of a master end journal volume according to the first embodiment of the present invention.

FIG. 7 is an example of a table for managing the configuration of a remote end journal volume according to the first embodiment of the present invention.

FIG. 8 is an example of a table for managing the relationship between a business volume and a journal volume according to the first embodiment of the present invention.

FIG. 9 is an example of a table for managing a CDP base volume according to the first embodiment of the present invention.

FIG. 10 is an example of a table for managing journal data within a master end journal volume in chronological order according to the first embodiment of the present invention.

FIG. 11 is an example of a table for managing journal data within a remote end journal volume in chronological order according to the first embodiment of the present invention.

FIG. 12 is an example of a table for associating a journal data sequence number within a master end journal volume with processing of journal data according to the first embodiment of the present invention.

FIG. 13 is an example of a table for associating a journal data sequence number within a remote end journal volume with processing of journal data according to the first embodiment of the present invention.

FIG. 14 is a flowchart illustrating processing for managing a master end journal volume according to the first embodiment of the present invention.

FIG. 15 is a flowchart illustrating report processing according to the first embodiment of the present invention when the available capacity of a master end journal volume is below a specified capacity.

FIG. 16 is a flowchart illustrating promotes processing according to the first embodiment of the present invention when the available capacity of a master end journal volume is below a specified capacity.

FIG. 17 is a flowchart illustrating journal inaccessible processing according to the first embodiment of the present invention when the available capacity of a master end journal volume is below a specified capacity.

FIG. 18 is a diagram showing an example of the configuration of a storage system including a computer according to the second embodiment of the present invention.

FIG. 19 is a diagram showing an example of the configuration of journal data within a journal data volume according to the second embodiment of the present invention.

FIG. 20 is a diagram showing an example of the configuration of a storage array at a local end according to the second embodiment of the present invention.

FIG. 21 is a diagram showing an example of the configuration of a storage array at remote end according to the second embodiment of the present invention.

FIG. 22 is a flowchart illustrating processing for managing a journal volume according to the second embodiment of the present invention.

FIG. 23 is a diagram showing an example of the configuration of a storage system including a computer according to the third embodiment of the present invention.

FIG. 24 is a diagram showing an example of the configuration of journal data within a journal data volume according to the third embodiment of the present invention.

FIG. 25 is a flowchart illustrating processing for managing a master end journal volume according to the third embodiment of the present invention.

FIG. 26 is a flowchart illustrating processing for managing a remote end journal volume according to the third embodiment of the present invention.

FIG. 27 is a diagram showing an example of the configuration of a management server according to the third embodiment of the present invention.

FIG. 28 is a diagram showing an example of the configuration of a management client according to the third embodiment of the present invention.

### DETAILED DESCRIPTION OF PREFERRED EMBODIMENTS

An embodiment of the present invention will be described below with reference to the attached drawings. It should be understood that the present invention is not limited to these embodiments.

### First Embodiment

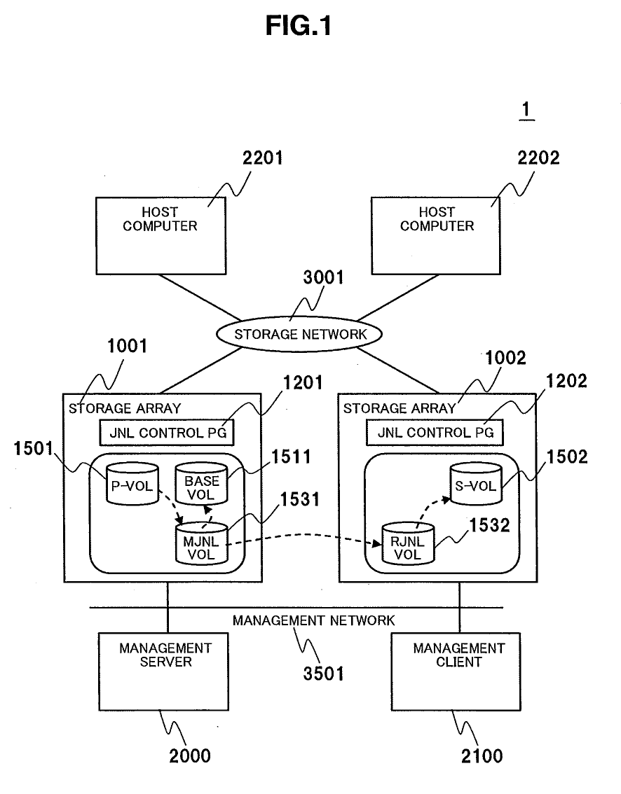

First, a first embodiment will be described. FIG. 1 is a block diagram showing a storage system 1 (including a computer) according to the first embodiment of the invention.

Host computers 2201 and 2202 are computers such as a personal computer, workstation, or mainframe, etc. In the host computers 2201 and 2202, application programs for various kinds of business or uses, such as databases, etc., are executed. Any number of host computers may connect to a storage array 1001 via a storage network 3001. Furthermore, the host computers 2201 and 2202 send and receive, to/from the storage array 1001, commands and data that are necessary for input and output during information processing; and when making changes to data, the host computers send a write request to the storage array. The host computer 2202 is equivalent to the host computer 2201, so its description will be omitted hereinafter.

The storage array 1001 receives a command or data transmitted via the storage network 3001; performs predetermined processing; and provides a predetermined response to the host computer 2201. A storage array 1002 holds a replica of data in the storage array 1001, and it is usually placed at a remote location (for the sake of simplicity, hereinafter referred to as a “remote site”); however, distance is no object. Furthermore, the storage array 1002 may communicate with the host computer 2201. The storage array 1002 is referred to as a “remote site,” but the storage array 1001 may be referred to as a “local site” or “master end.”

A management server 2000 is a computer for managing the configuration, maintenance and performance, etc. of the storage array 1001 or 1002 via a management network 3501. A management client 2100 is a computer for connecting to the management server 2000 from a remote location, and for using a management function in the management server. Moreover, the management client 2100 is optional. The management server 2000 is necessary only when performing the aforementioned management, so after completing settings necessary for implementing the invention, the management server 2000 is not essential. Also, the management server 2000 connects to the storage network 3001, so that it can be configured to not use the management network 3501 (for example, managing In-Band only).

The flow of the entire processing will be described below, with the details to be described later. The storage array 1001 stores data input from the host computer 2201 in a business volume (P-VOL1501). When data is written to the P-VLO1501, a journal control program (JNL control program PG1201) writes update data to a master journal volume (MJNL VOL1531) as journal data. In order to protect data in the P-VOL1501 using a CDP function, the JNL control program PG1201 provides journal data retained beyond a target retention period to a base volume (base VOL1511 or BVOL1511). Furthermore, data in the P-VOL1501 is transferred to a remote journal volume (RJNL VOL1532) at a remote site by using an asynchronous copy function. A JNL control program PG1202 at remote site end provides journal data in the RJNL VOL1532 to a secondary volume (S-VOL1502).

Control of the transfer of the journal data in the MJNL VOL1531 to the RJNL VOL1532 using the asynchronous copy function may be performed at the remote end, according to the remote end convenience. Furthermore, the physical media constituting the volumes described herein may be not only hard disk drives (including RAID), but also flash memory or magnetic tape, however, it is not limited to these media.

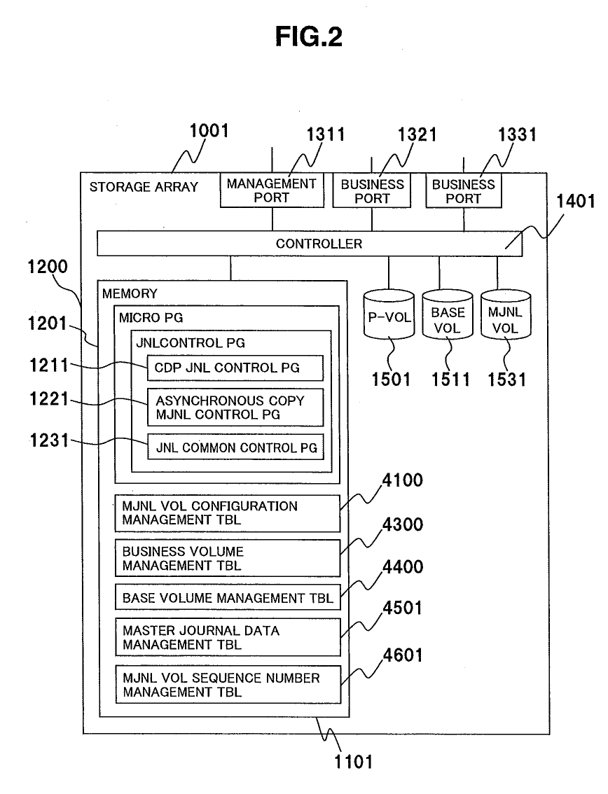

FIG. 2 is a block diagram showing the configuration of the interior of the storage array 1001. A data reference request or a write request from the host computer 2201 to a business volume is received by a controller 1401 via a business port 1321 or 1331. The controller 1401 performs storing (write) or readout (read) of data in or from the appropriate business volume (P-VOL1501) in accordance with the association between a predetermined business volume and the host computer 2201. In that case, a high-speed I/O may be performed using an internal high-speed cache.

Requests from management server 2000 managing configuration setting and maintenance, etc., are received by the controller 1401 via a management port 1311. With regard to configuration setting, configuration information held in internal cache memory, etc., is updated, and various changes such as configuration change of a volume and copying-related establishment, etc., are performed. The management port 1311 may share the same port with the business port 1321 or 1322.

Programs executed in the controller 1401 are loaded to memory 1101, thereby respective programs are controlled from a micro program PG1200. In that case, the JNL control program PG1201 is merely an abstraction of a CDP JNL control program PG1211, an asynchronous copy MJNL control program PG1221, and a JNL common control program PG1231, and it does not indicate any structural relationship between the respective control programs. Moreover, management information the JNL control program PG1201 uses during operation is held as a management table (TBL) in memory 1101. However, this management information is not required to be held in the memory 1101, it only has to be held in a place accessible from the JNL control program PG1201, such as a management system disk, etc.

The management tables held in the memory 1101 are, as shown in FIG. 2, an MJNL VOL configuration management table 4100, a business volume management table 4300, a base volume management table 4400, a master journal data management table 4501 and an MJNL VOL sequence number management table 4601. These management tables will be described below.

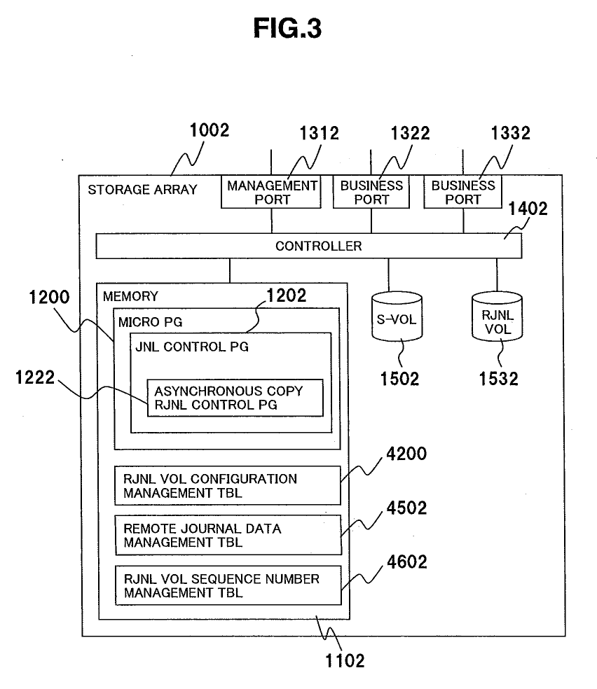

FIG. 3 is an example of the configuration of the interior of a storage array 1002 at remote site, and it is basically identical to that of the storage array 1001. In this case, the S-VOL1502 is a volume for holding the replication data of the P-VOL1501, but not for receiving a write from the host computer 2201.

The management tables held in the memory 1102 are, as shown in FIG. 3, a RJNL VOL configuration management table 4200, a remote journal data management table 4502 and a RNJL VOL sequence number management table 4602. These management tables will be described below.

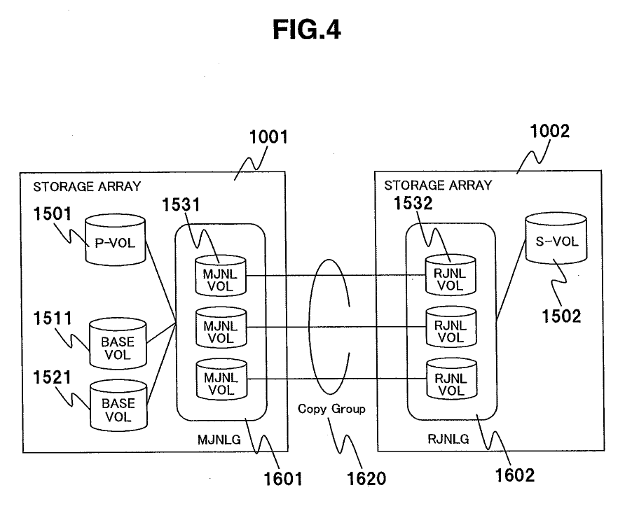

FIG. 4 is a block diagram showing the configuration of an entire storage system 1. The storage array 1001 and the storage array 1002 at remote site end are interconnected via the storage network 3001 or a private network. The asynchronous copy function uses a JNL VOL when transferring data from P-VOL1501 to S-VOL1502. One or more JNL VOLs can be associated with the P-VOL1501 as one cache, and they are referred to as journal groups. The journal groups are arranged at both the local site and remote site, and are respectively referred to as MJNLG1601 and RJNL1602. Copies associated between journal groups are defined as copy groups 1620.

The copy group 1620 described herein is an identifier related to copying between journal volumes; however, it does not ensure the order of data updates in different journal volumes. Moreover, when associating a single journal volume as MJNL VOL1531 or RJNL VOL1532, copy groups and journal groups are not required to be controlled on a group basis. One or more base VOLs1511 can be arranged during the target retention period. The difference in journal data can be reduced by arranging the base VOL1511 as shown in FIG. 4, the journal data is provided in order to, when a failure occurs, recover data at a particular point in time. As a result, the amount of time for recovery can be shortened.

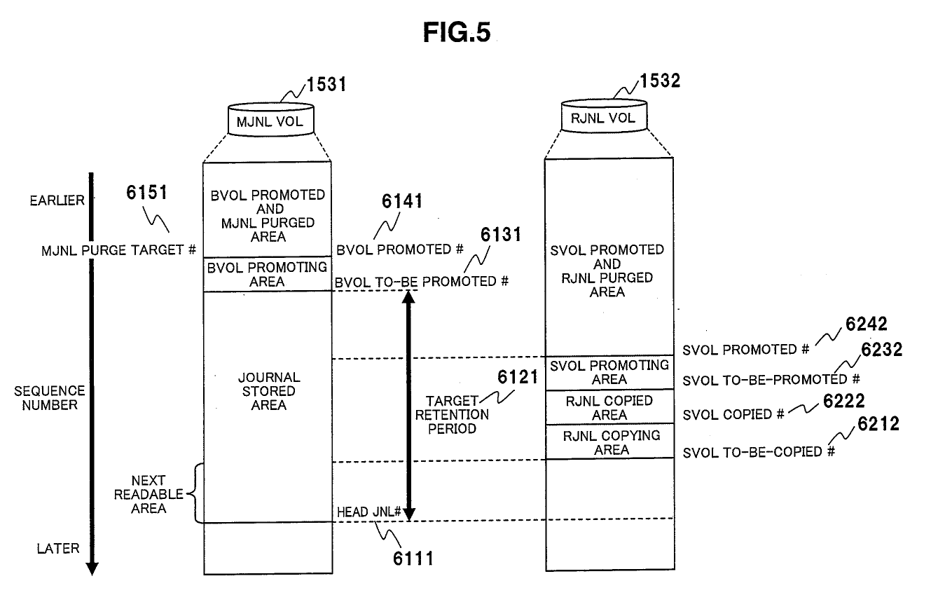

FIG. 5 is a diagram showing the example of the structure of journal data within a journal volume. Updated data in P-VOL1501 is, as journal data, associated with sequence numbers in chronological order, and then stored in MJNL VOL1531. During storing, the latest journal data in MJNL VOL1531 is associated with the head JNL#6111. The journal data associated with the sequence numbers from the head JNL#6111 to the MJNL purge target #6151 described below are regarded as accessible journal data.

The asynchronous copy function copies journal data from the MJNL VOL1531 to the RJNL VOL1532 using the asynchronous copy MJNL control program PG1221 and an asynchronous copy RJNL control program PG1222. Journal data and associated sequence numbers in the MJNL VOL1531 are the same as those in the RJNL VOL1532.

The asynchronous copy RJNL control program PG1222 retrieves the journal data, which does not exist in the RJNL VOL1532, from the JNL VOL1532 at a set time. One of the sequence numbers from the head JNL#6111 to a RJNL copied #6222 is designated as a RJNL to-be-copied #6212, the RJNL to-be-copied #6212 is journal data that is a copy target for being copied to the RJNL VOL1532 side. Providing journal data from a JNL VOL to a SVOL or a BVOL is referred to as an promote. Among the sequence numbers of journal data that has been promoted to S-VOL1502, the latest (the largest) number is set as a SVOL promoted #6242. The S-VOL promoted #6242 and the journal data having earlier numbers are regarded as able to be overwritten or deleted. The asynchronous copy RJNL control program PG1222 authorizes overwriting of the other journal data or deletes the journal data (hereinafter this may be referred to as “purge”). When S-VOL promoted #6242 is updated, the asynchronous copy RJNL control program PG1222 reports the updated SVOL promoted #6242 to the JNL common control program PG1231.

The CDP function can recover data at a given point in between the current time and a predetermined target retention period 6121. The journal data retained beyond the target retention period 6121 is promoted to a BVOL. The journal data that is promoted can be regarded as unnecessary for the CDP function. The CDP JNL control program PG1211 sets a BVOL to-be-promoted #6131 as a target for promotes, and a BVOL promoted #6141 as the journal data that has been promoted. When the BVOL promoted #6141 is promoted, the CDP JNL control program PG1211 reports the promoted BVOL promoted #6141 to the JNL common control program PG1231.

After receiving the report, or at a set time, the JNL common control program PG1231 compares an promoted # with the MJNL purge target #6151; if there is a number earlier (a number smaller) than the MJNL purge target #6151, the JNL common control program PG1231 sets the earliest number as the MJNL purge target #6151. Within the MJNL VOL1531, the MJNL purge target #6151 and the journal data having earlier numbers are regarded as able to be overwritten or deleted. The JNL common control program PG1231 authorizes overwriting the other journal data or deletes the journal data.

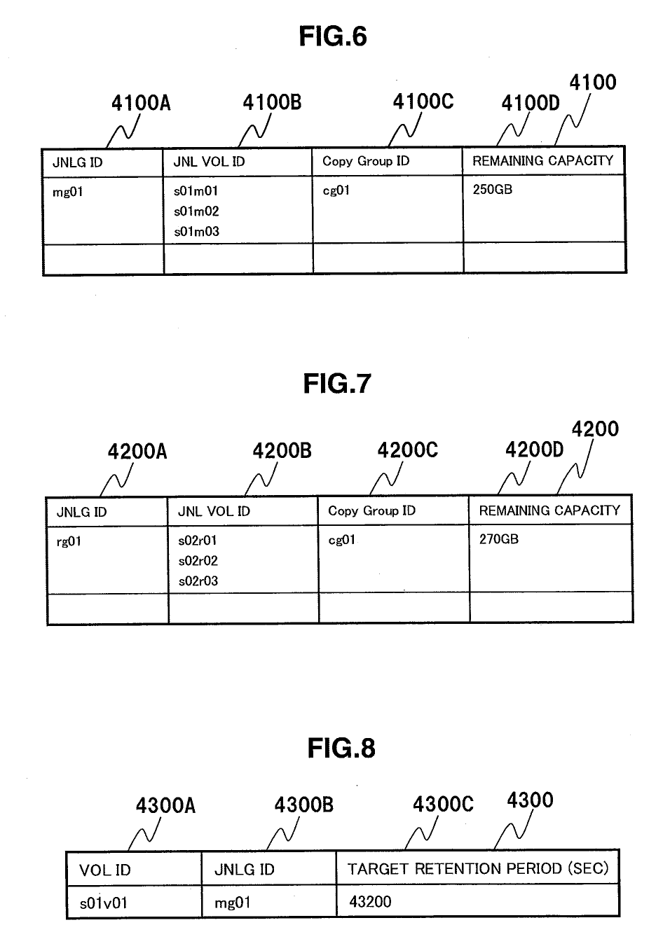

Tables for managing the configuration of a journal volume according to the invention are shown in FIGS. 6 and 7. FIG. 6 is a diagram showing an example of an MJNL VOL configuration management table 4100 managing the configuration of a master end journal volume. FIG. 7 is a diagram showing an example of a RJNL VOL configuration management table 4200 managing the configuration of a remote end journal volume.

The JNL control program PG1211 manages, by using the MJNL VOL configuration management table TBL4100, associating a journal volume (4100B) constituting the master end journal group, a remaining capacity (4100D) and a copy pair (4100C) with one another. Also, the JNL control program PG1212 manages, by using the RJNL VOL configuration management table TBL4200, associating a journal volume (4200B) constituting a remote end journal group, remaining capacity (4200D), and a copy pair (4200C) with one another. With respect to the remaining capacity, the JNL control program PG1212 regularly or serially monitors the value of the remaining capacity in cooperation with the micro program-program 1200, etc.; and if the value changes, the JNL control program PG1212 updates the tables. When a plurality of journal groups exist, tables in FIGS. 6 and 7 may have a plurality of entries. Furthermore, a plurality of remote end journal groups may be configured for one master end journal group (multi-target configuration).

FIG. 8 is a diagram showing an example of a business volume management table 4300 defining a relationship between a business volume and a journal volume. The relationship between a journal volume at a master end and a journal volume at a remote end is defined in a management table 4100 and 4200, so the business volume management table 4300 defines a journal volume group (4300B) at the master end only. Furthermore, the period during which the CDP function retains data in the business volume is preset as a target retention period (4300C).

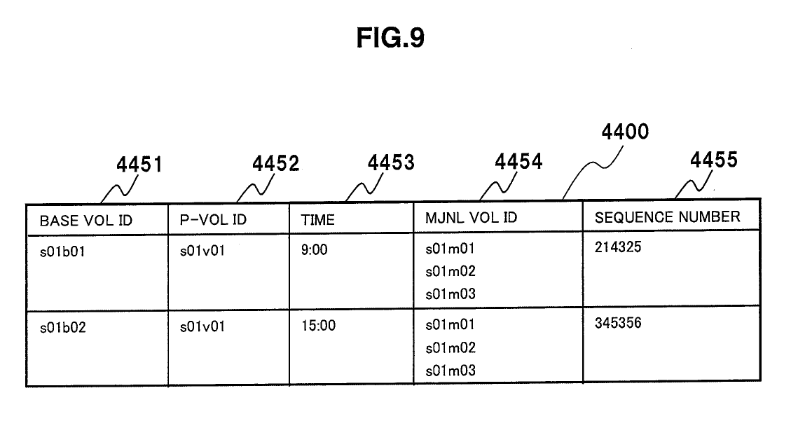

FIG. 9 shows a base volume management table 4400, which manages the configuration of the base volume of the CDP function. The base volume management table TBL4400 defines which base volume is the backup of which business volume, and at which point in time; and it also defines which MJNL will be a target, and which sequence number will be associated next. The BVOL promoted #6141, which will be a criterion for determining the MJNL purge target #6151, is provided to the sequence number which is one less number than the sequence number 4451 of the base volume having the earliest time of last access.

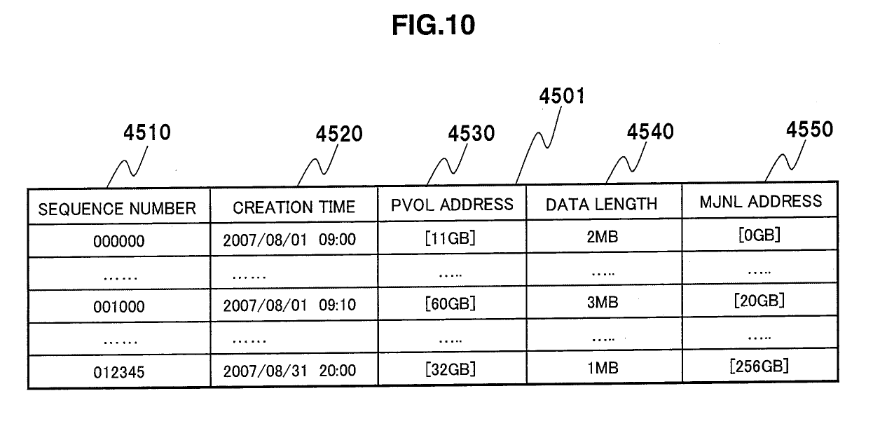

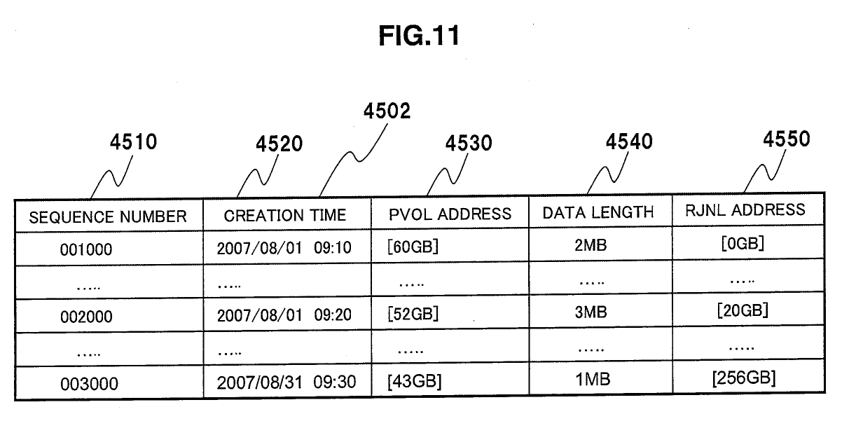

FIGS. 10 and 11 show tables for managing journal data within a journal volume in chronological order. FIG. 10 is a diagram showing an example of a master journal data management table 4501, which is for managing journal data within a master end journal volume in chronological order. FIG. 11 is a diagram showing an example of a remote journal data management table 4502 which is for managing journal data within a remote end journal volume in chronological order.

Each journal data is associated with a sequence number 4511, and stored in the MJNL VOL1531. The master journal data management table 4501 of the MJNL VOL1531 includes a time when journal data is written by a business host (creation time 4520), location where journal data is stored in a business volume (PVOL address 4530), data length 4540, and location where journal data is stored in an MJNL VOL (MJNL address 4550). In the figures, for descriptive purposes, an address on a volume is specified by capacity; however, a method for specifying an address is not limited to any specific method. For example, a block address may be specified by serial numbers such as an LBA (Logical Block Address). Also, a method for specifying an address by cylinder/head/sector, may be used. The remote journal data management table 4502 of the RJNL VOL1532 includes management items equivalent to those in the master journal data management table 4501.

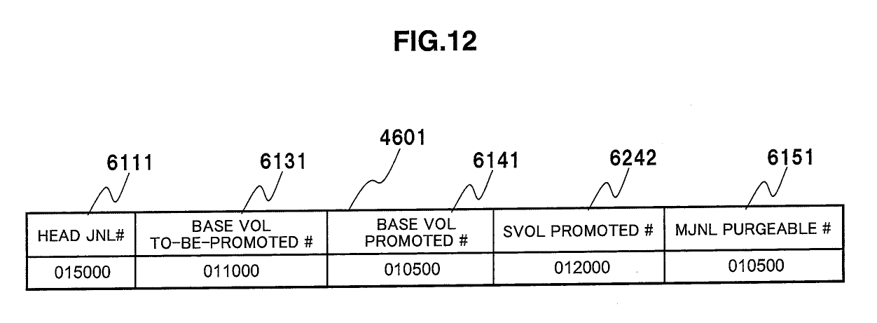

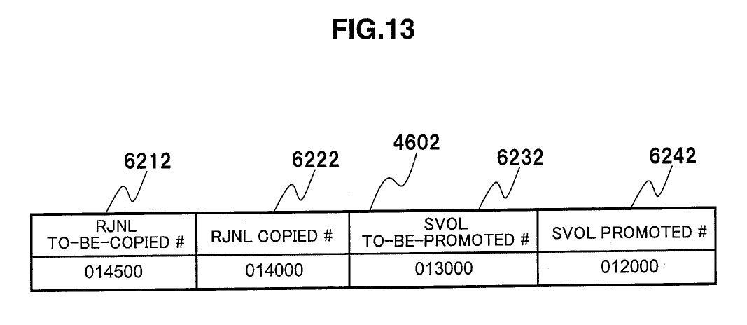

FIGS. 12 and 13 show management tables for associating a flag used in processing for controlling journals, such as the head JNL#6111 shown in FIG. 5, with the sequence number of journal data. FIG. 12 is a diagram showing an example of an MJNL VOL sequence number management table 4601 for associating the sequence numbers of journal data within the master end journal volume with processing of journal data. FIG. 13 is a diagram showing an example of a RJNL VOL sequence number management table 4602 for associating the sequence numbers of journal data within a remote end journal volume with processing of journal data. The JNL control program PG1201 managing an MJNL VOL keeps the MJNL VOL sequence number management table 4601 up-to-date, and performs processing such as promoting to a base VOL and purging, etc.

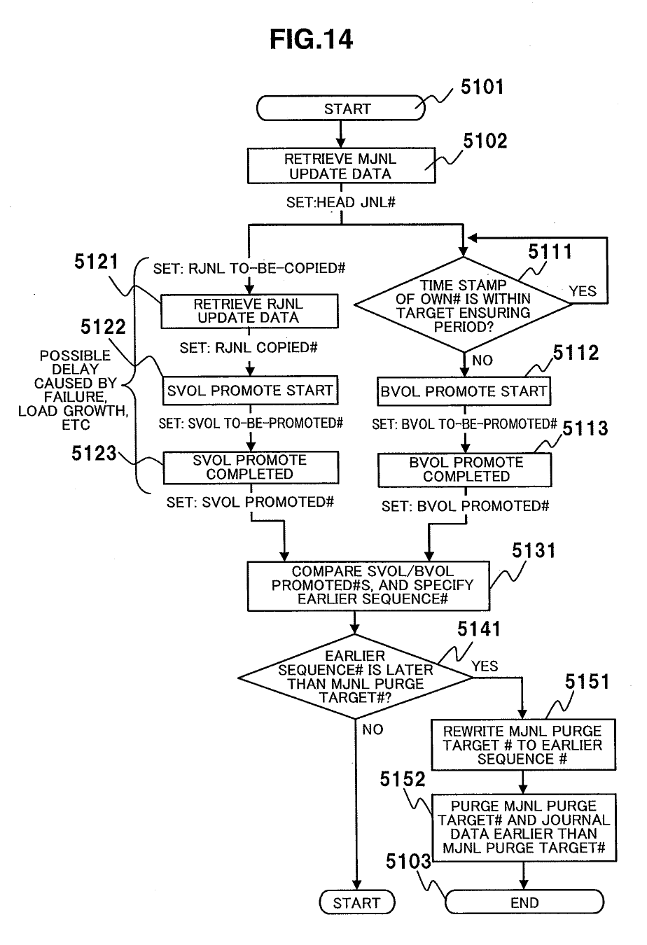

FIG. 14 is a flowchart illustrating processing for managing the master end journal volume. The flow of processing will be described below with reference to FIG. 14. In an MJNL update data retrieval 5101, when an update exists in P-VOL1501, the JNL control program PG1201 writes update data to an MJNL as journal data. In that case, a head JNL# in the MJNL VOL sequence number management table TBL4601 is updated to the sequence number of the latest journal data that was updated. Then, the CDP function and the asynchronous copy function perform processing independently.

In the asynchronous copy function, the asynchronous copy MJNL control program PG1221 reports to the asynchronous copy RJNL control program PG1222 that update data is written to the MJNL VOL1531. The asynchronous copy RJNL control program PG1222 changes an RJNL to-be-copied #6212 in the RJNL VOL sequence number management table TBL4602 within a range where update data exists, and then arbitrarily copies journal data from the MJNL VOL1531 (RJNL update data retrieve 5121). After completion of copying, the latest journal data copied to the RJNL VOL1532 is set as an RJNL copied #6222. The asynchronous copy RJNL control program PG1222 determines, from the SVOL promoted # to the RJNL copied #6222, the range of journal data that is a target for promoting to the S-VOL1502; and then sets the range in RJNL VOL sequence number management table TBL4602 as a S-VOL to-be-promoted #6232 (SVOL promote start 5122). When the promoting to the S-VOL1502 is completed (SVOL promote completed 5123), the latest journal data among the post-promote journal data is set in the RJNL VOL sequence number management table TBL4602 as an SVOL promoted #6242; and the aforementioned sequence number 6242 is reported to the JNL common control program PG1231 of the storage array 1001. Normally, promoting to SVOL is performed immediately after a journal is updated; however, it may be delayed because of a failure or a load increase.

In the CDP function, the CDP JNL control program PG1211 determines, in accordance with the target retention period 6121 which is set in a business volume management table TBL4300, the previous time when data should go back to, based on the current time; and specifies, from a master journal data management table TBL4501, the sequence number of the journal data that is the latest prior to the aforementioned previous time (FIG. 14: 5111). If this sequence number is later (larger) than a base VOL to-be-promoted #6131 in the MJNL VOL sequence number management table TBL4601, the CDP JNL control program PG1211 replaces the base VOL to-be-promoted #6131 with the aforementioned sequence number. The CDP JNL control program PG1211 performs a BVOL promote on earlier sequence numbers, within a range from BVOL promoted #6141 or later to before BVOL to-be-promoted # (BVOL promote start 5112). Then, the latest journal data from among the post-promote journal data is set as a BVOL promoted #6141 in the MJNL VOL sequence number management table TBL4601, and the aforementioned sequence number 6241 is reported to the JNL common control program PG1231 (BVOL promote completed 5113).

The JNL common control program PG1231 waits for a report from a JNL control program PG, that an promote is completed; and when it receives any or both reports, starts to perform processing for determining whether or not journal data in an MJNL VOL should be purged. The decision is made by comparing the SVOL promoted #6242 with the BVOL promoted #6141 (5131); and specifying an earlier sequence number (5141).

If this earlier sequence number is later (larger) than the MJNL purge target #6151, the MJNL purge target #6151 is replaced with the aforementioned earlier sequence number (5151). Out of the journal data having an MJNL purge target # and a sequence number earlier than the MJNL purge target #, the JNL control program PG authorizes, with respect to the journal data that is not purged, overwriting of the other journal data or deletes the journal data (MJNL purge execution 5152).

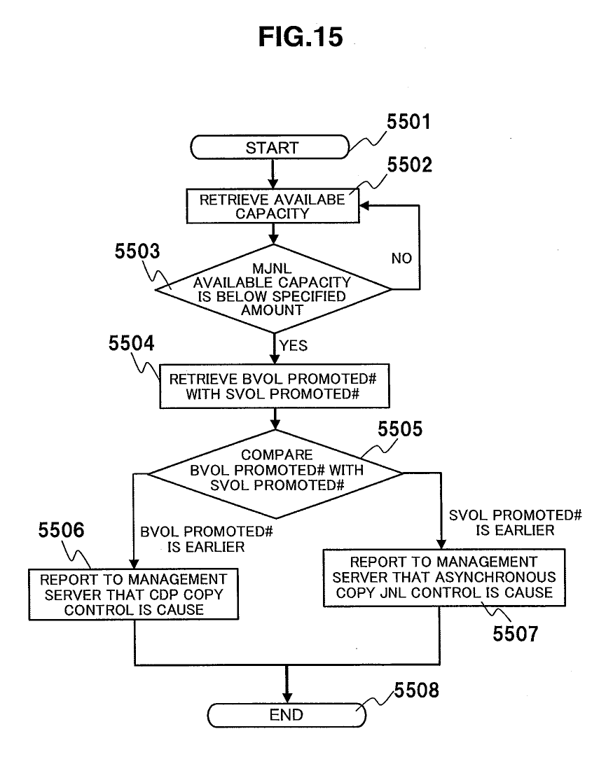

If purges to the journal data in the MJNL VOL1531 are too much for the capacity of the journal volume in the MJNL VOL1531, the MJNL VOL1531 cannot make additional writes beyond the capacity, so a write failure may occur. When this failure occurs, or is likely to occur, the flow of processing for specifying which of the CDP function and the asynchronous copy function caused the failure is shown in FIG. 15.

As shown in FIG. 15, the JNL control program PG1201 acquires the available capacity of the MJNL VOL1531 from the MJNL VOL configuration management table TBL4100 (5502), and monitors whether or not the available capacity is below the specified amount (5503). If the available capacity is below the specified amount (5503: YES), the JNL control program PG1201 retrieves BVO promoted # and SVOL promoted # to determine which of the CDP function and the asynchronous copy function caused the failure (5504), and compares BVOL promoted #6141 with SVOL promoted #6242 (5505). After the comparison, the JNL control program PG1201 reports to the management server 2000 the result that the function having an earlier sequence number (i.e. if BVOL promoted #) is the earlier sequence number, the function causing the failure is the CDP function; and if the earlier sequence number is SVOL promoted #, the function causing failure is the asynchronous copy function) is the reason of a failure (5506, 5507).

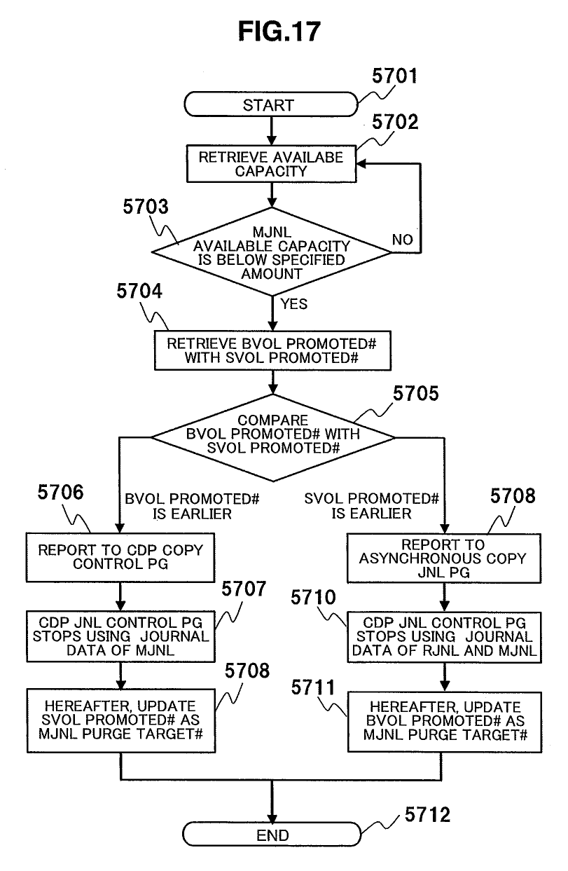

Journal suspension processing for when the available capacity of the master end journal volume goes below the specified amount is shown the flowchart in FIG. 17. As described above, processing for stopping updates of the MJNL VOL1531 is performed to prevent the journal data from overflowing and causing a write failure. Specifically, as shown in FIG. 17, the JNL control program PG1201 retrieves the remaining capacity of the MJNL VOL1531 from the MJNL VOL configuration management table TBL4100 (5702); if the remaining capacity exceeds a predetermined capacity threshold (5703: YES), the JNL control program PG1201 acquires BVO promoted # and SVOL promoted # (5704); and compares BVOL promoted #6141 with SVOL promoted #6242 (5705). Then, after performing reporting (5707, 5708), the JNL control program PG1201 stops updating the MJNL VOL1531, or the MJNL VOL1531 and the RJNL VOL1532 (5707, 5710). After stopping updates, the JNL control program PG1201 may proceed to control the difference between SVOL or BVOL and PVOL in bitmaps (5708, 5711).

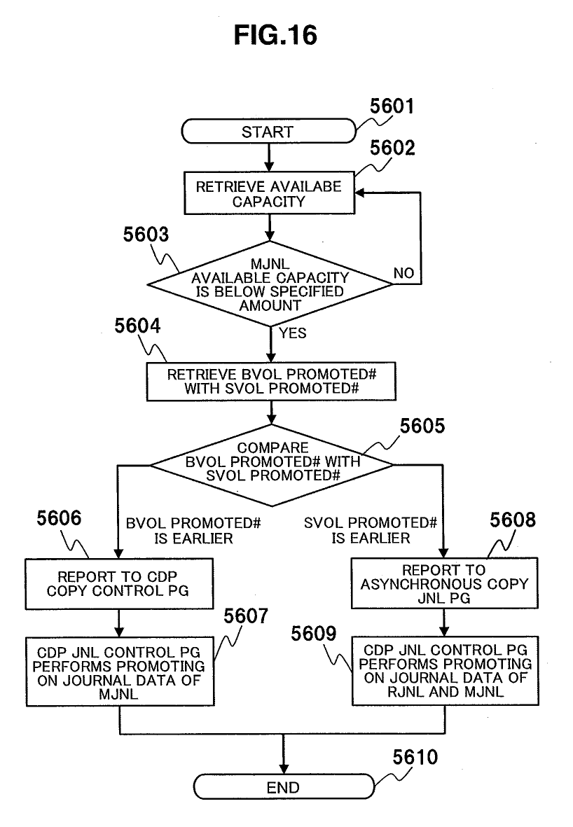

Otherwise, even if the remaining capacity exceeds the aforementioned predetermined capacity threshold, the JNL control program PG1201 may not stop updating and may perform processing for promoting. FIG. 16 is a flowchart illustrating promotes processing when the available capacity of the master end journal volume is below the specified amount. As shown in FIG. 16, the data overflow of the MJNL VOL1531 may be prevented, by changing the to-be-promoted # of BVOL or SVOL and performing early promoting and purging (5607, 5609). Specifically, which of the CDP function and the asynchronous copy function overburdens the capacity is determined by comparing BVOL promoted #6141 with SVOL promoted #6242 (5605), and the journal data which the function causing a failure uses (difference between BVOL promoted #6141 and SVOL promoted #6242) is purged.

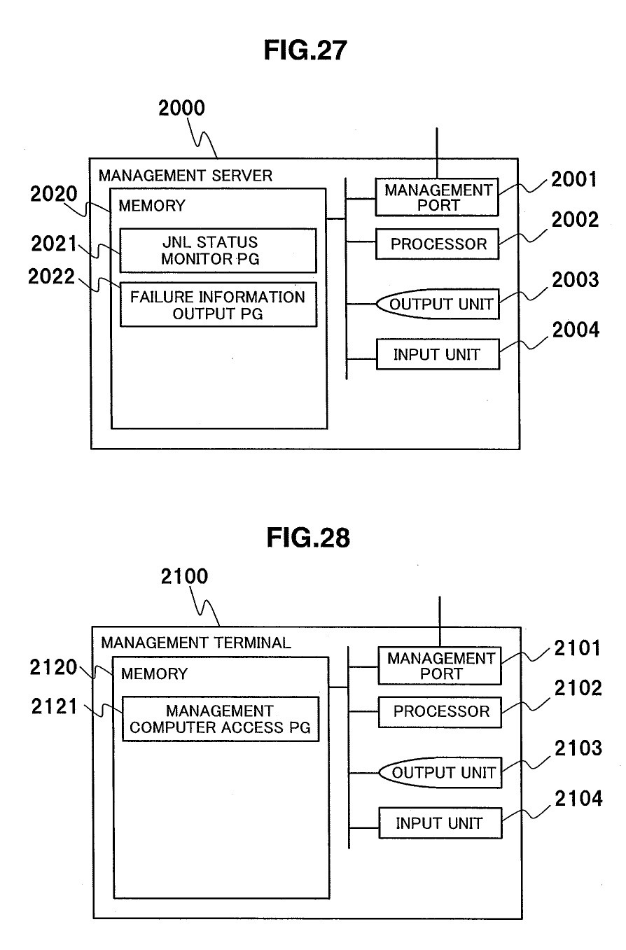

FIG. 27 is a block diagram showing a management server 2000, and FIG. 28 is a block diagram showing a management client 2100. When the capacity of the journal volume is below a specified amount, the management server 2000 receives a report from the storage array 1021 via the management port 2001. When a JNL status monitor program PG2021 receives a report, it instructs a failure information output program PG2022 to provide the content of the report to an administrator using a screen (output unit 2003) or an email, etc. The report content includes the function causing the aforementioned failure, a volume ID, and the remaining capacity, etc. The management client 2100 accesses the management sever 2000 from a remote location via the management port 2101 using management computer access program PG2121, so that it can retrieve the aforementioned report content.

According to the first embodiment, even if the storage system 1 uses the CDP function in the storage array 1001, and also uses the asynchronous copy function in the storage array 1001 and the storage array 1002 at the same time, the storage system 1 can reduce the volume usage amount of the storage array 1001,1002 and computational resources for journal control by deleting journal data that is not necessary for both functions.

### Second Embodiment

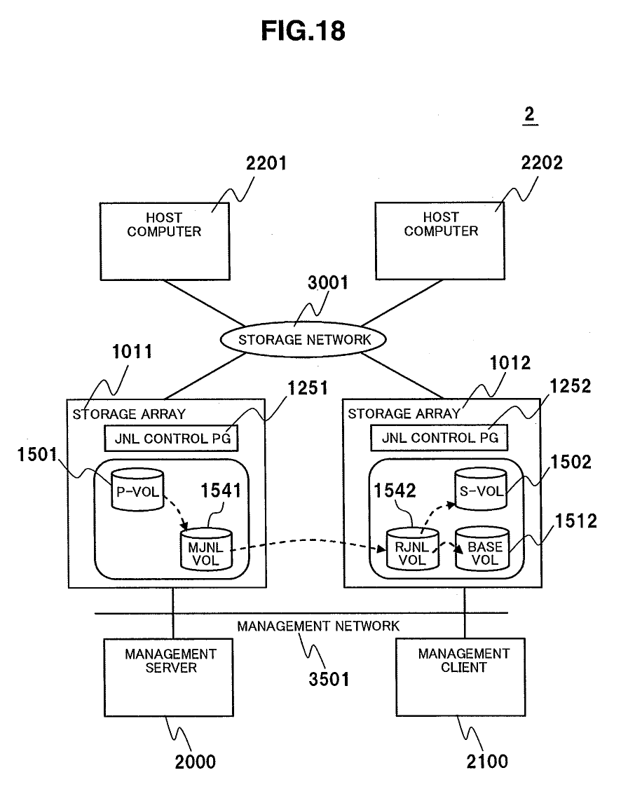

Next, a second embodiment will be described below. In the second embodiment, relative to the above-described first embodiment, the case where the journal volume-sharing is performed at remote site end will be described. FIG. 18 is a block diagram showing the storage system 2 (including the host computer) according to the second embodiment. The host computer 2201, 2202, the storage array 1011, 1012, and the management server are basically the same as those in FIG. 1, so their descriptions will be omitted.

The storage array 1011 stores data input from the host computer 2201 in a business volume (P-VOL1501). When data is written to the P-VOL1501, a journal control program (JNL control program PG1251) writes update data to a master journal volume (MJNL VOL1531) as journal data. Data in the P-VOL1501 is transferred to a remote journal volume (RJNL VOL1532) at a remote site by using the asynchronous copy function. The JNL control program PG1252 at the remote site end provides journal data in the RJNL VOL1532 to a secondary volume (S-VOL1502). Furthermore, in order to protect data in the P-VOL1501 at the remote end using the CDP function, the JNL control program PG1252 provides journal data expiring the target retention period to a base volume (base VOL1512 or BVOL1512). Transferring the journal data in the MJNL VOL1531 to the RJNL VOL1532 using the asynchronous copy function may be controlled at the remote end, according to the remote end convenience.

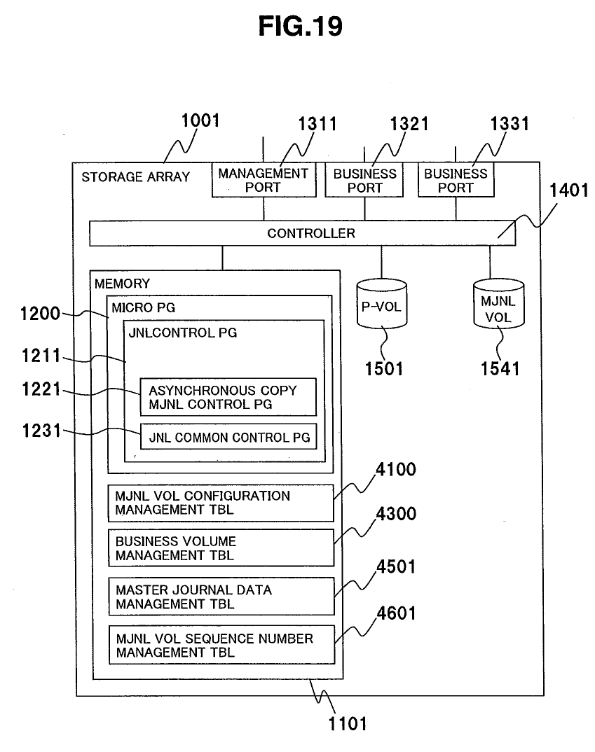

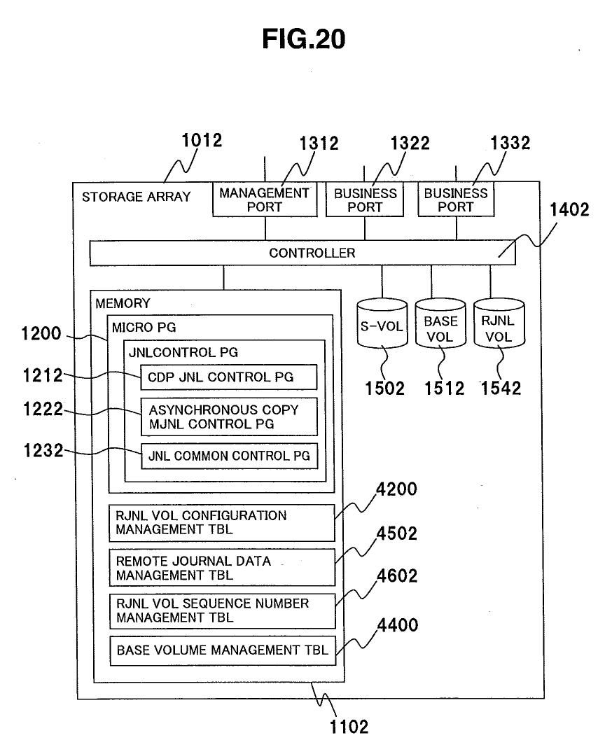

FIG. 19 is a block diagram showing the configuration of the interior of a storage array 1011. Components, such as a management port 1311, business ports 1321, 1331, a controller 1401, and memory 1101, etc., are the same as those on FIG. 2, so their descriptions will be omitted. FIG. 20 is a block diagram showing the configuration of the interior of a storage array 1012. Components, such as a management port 1312, a business port 1322, 1332, a controller 1402, and memory 1102, etc., are the same as those on FIG. 3, so their descriptions will be omitted. FIGS. 19 and 20 are different from FIG. 2 and FIG. 3 in arranging the base VOL1512 and the base volume management table TBL4400 inside the storage array 1012 in order to perform the CDP function at the remote end.

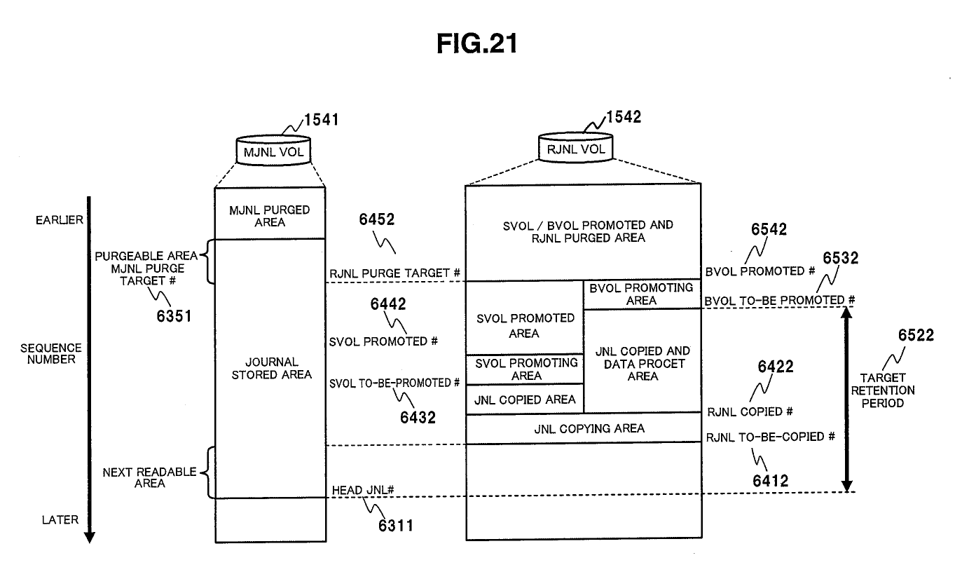

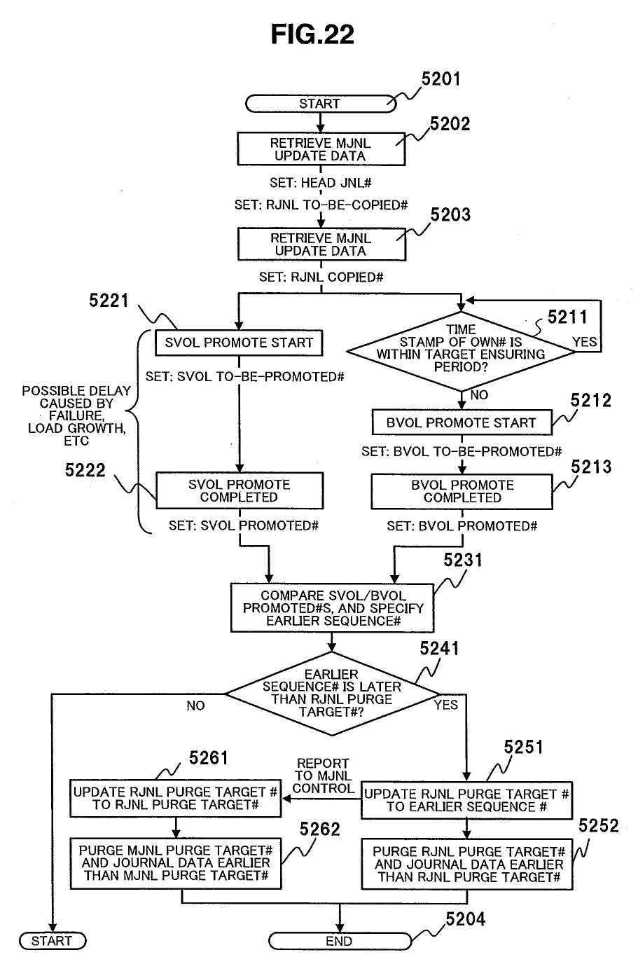

FIG. 21 shows the structure of journal data in the journal volume. FIG. 22 is a flowchart illustrating processing for managing the journal volume.

The outline of processing will be described below. Update data in the P-VOL1501 is, as journal data, associated with sequence numbers in chronological order, and then stored in the MJNL VOL1541. When storing, the latest journal data in the MJNL VOL1541 is associated with the head JNL#6311. The journal data associated with the sequence numbers from the head JNL#6311 to the MJNL purge target #6351 are regarded as accessible journal data.

The asynchronous copy function copies journal data from an MJNL VOL1541 to an RJNL VOL1542 using the asynchronous copy MJNL control program PG1221 and the asynchronous copy RJNL control program PG1222 (5203). Journal data and associated sequence numbers in the MJNL VOL1541 are the same as those in the RJNL VOL1542. The asynchronous copy RJNL control program PG1222 retrieves the journal data, which does not exist in the RJNL VOL1542, from JNL VOL1542 at a set time. One of the sequence numbers from head JNL#6111 to RJNL copied #6222 is designated as RJNL to-be-copied #6212, the RJNL to-be-copied #6212 is journal data that is a copy target for being copied to the RJNL VOL1542 side (5221). Of the sequence numbers for journal data that has been promoted to the S-VOL1502, the latest (the largest) number is set to be as an SVOL promoted #6242 (5222). When the S-VOL promoted #6242 is updated, the asynchronous copy RJNL control program PG1222 reports the updated SVOL promoted #6242 to the JNL common control program PG1232.

The CDP function can recover data at a given point between the current time and a predetermined target retention period 6522. The journal data retained beyond the target retention period 6522 (5211: NO), is promoted to a BVOL (5212). The journal data that is promoted can be regarded as unnecessary for the CDP function. The CDP JNL control program PG1212 sets a BVOL to-be-promoted #6532 as a target for promotes, and a BVOL promoted #6542 as the journal data that has been promoted (5213). When the BVOL promoted #6542 is promoted, the CDP JNL control program PG1212 reports the promoted BVOL promoted #6542 to the JNL common control program PG1232.

The JNL common control program PG1232 specifies, after receiving the report or at a set time, the earliest sequence number from among the reported promoted #s (5231). If the aforementioned earliest sequence number is later (the number is larger) than the RJNL to-be-purged #6452 (5241: YES), the aforementioned earliest sequence number is set to be the RJNL to-be-purged #6452 (5251). If any change is made in the settings, the JNL common control program PG1232 reports the RJNL to-be-purged #6452 to the JNL common control program PG1231, and performs purging at a set time (5252).

The JNL common control program PG1231 compares, after receiving the report or at a set time, the RJNL to-be-purged #6452 with the MJNL purge target #6351; if the RJNL to-be-purged #6452 is later than the MJNL purge target #6351, the JNL common control program PG1231 sets the RJNL to-be-purged #6452 as the MJNL purge target #6351 (5261). The same steps are followed in executing purging (5262).

According to this second embodiment, when performing journal volume-sharing at remote site end, the same advantageous effect as that of the first embodiment can be achieved.

### Third Embodiment

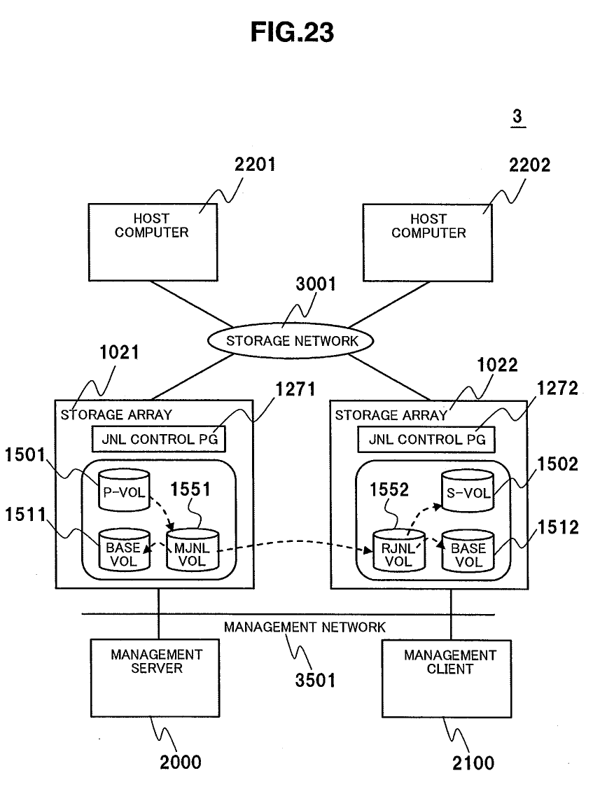

Next, a third embodiment will be described below. In the third embodiment, relative to the first and second embodiments, the case where the journal volume-sharing is performed both at local site end and at remote site end will be described. FIG. 23 is a block diagram showing the storage system 3 (including the host computer) according to the second embodiment. The host computer 2201, 2202, the storage array 1021, 1022, and the management server are basically the same as those in FIG. 1, so their descriptions will be omitted. Furthermore, components the same as those in the first and second embodiments will be numbered with the same reference numerals as those used in the first and second embodiments, so they will not be shown in figures, and their detailed descriptions will be omitted.

The storage array 1021 stores data input from the host computer 2201 in a business volume (P-VOL1501). When data is written to the P-VOL1501, a journal control program (JNL control program PG1271) writes update data to a master journal volume (MJNL VOL1551) as journal data. Data in the P-VOL1501 is transferred to a remote journal volume (RJNL VOL1552) at a remote site by using the asynchronous copy function. The JNL control program PG1272 at the remote site end provides journal data in the RJNL VOL1552 to a secondary volume (S-VOL1502). Furthermore, in order to protect data in the P-VOL1501 using the CDP function, at the local end, the JNL control program PG1271 provides journal data retained beyond the target retention period to a base volume (base VOL1511 or BVOL1511); at the remote end, the JNL control program PG1272 provides journal data retained beyond the target retention period to a base volume (base VOL1512 or BVOL1512). Transferring the journal data in the MJNL VOL1551 to the RJNL VOL1552 using the asynchronous copy function may be controlled at the remote end, according to the remote end convenience.

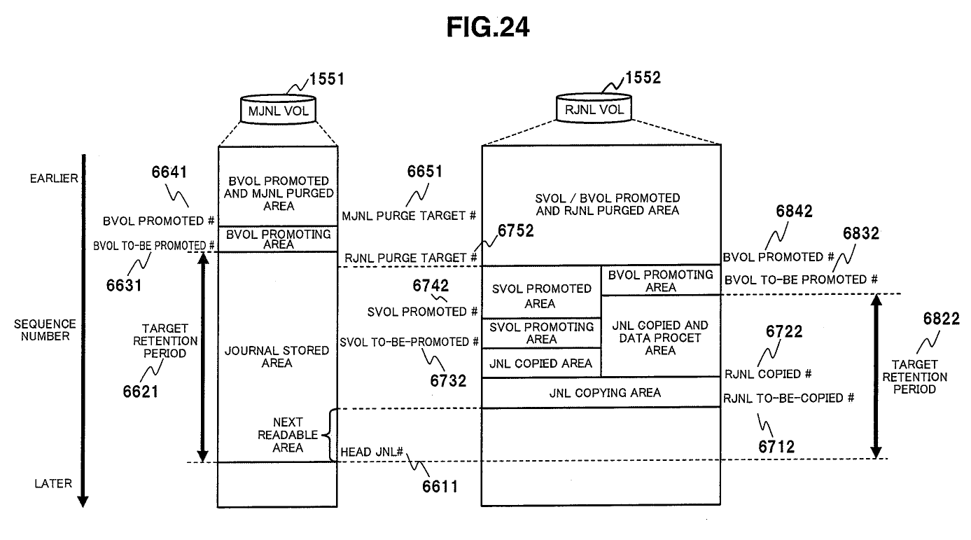

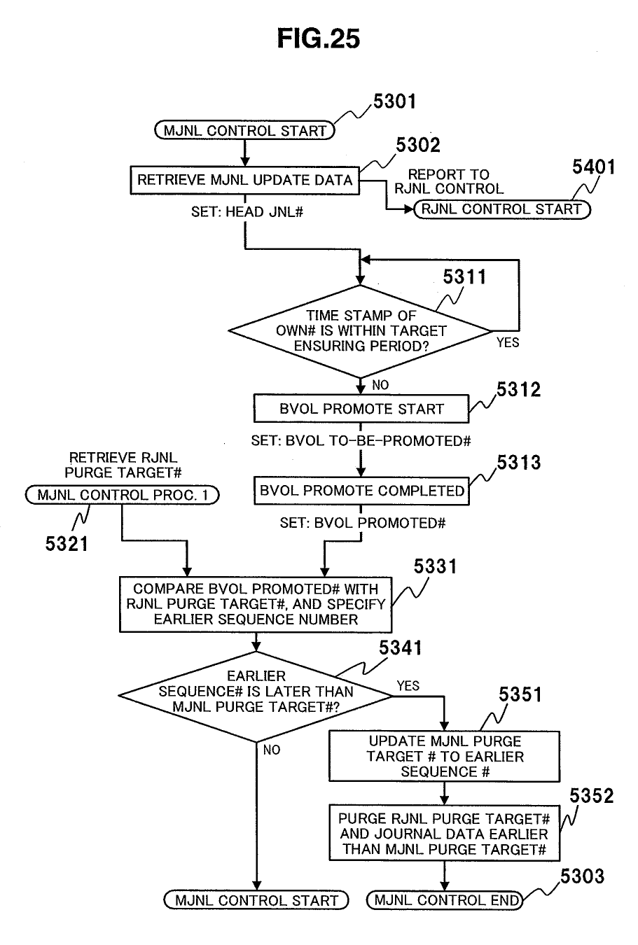

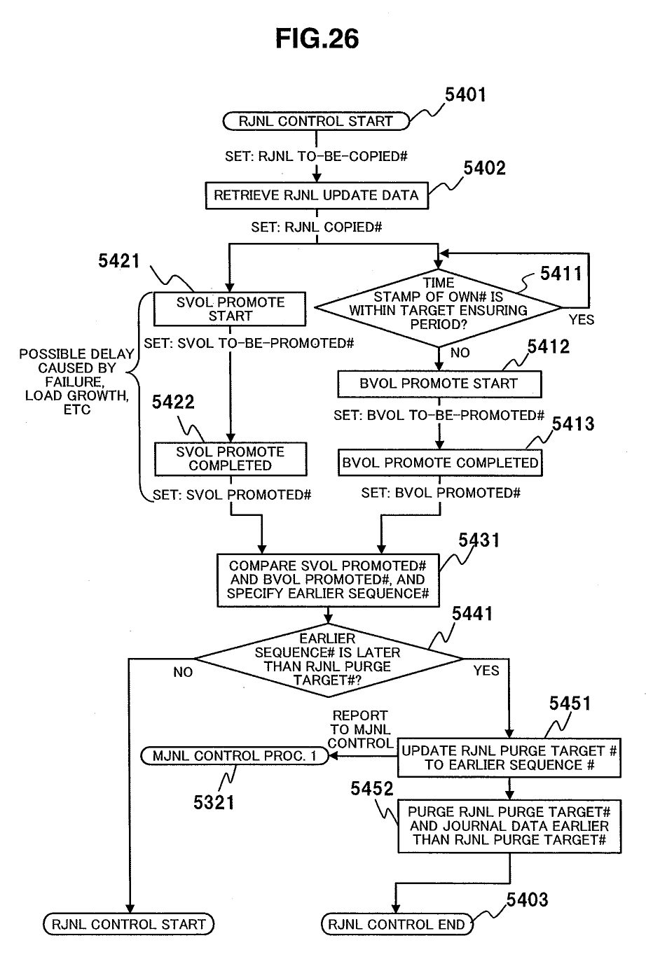

FIG. 24 is a diagram showing the structure of journal data in a journal volume. FIG. 25 is a flowchart illustrating processing for managing an MJNL end journal volume, and FIG. 26 is a flowchart illustrating processing for managing an RNNL end journal volume.

The outline of processing will be described below. Update data in the P-VOL1501 is, as journal data, associated with sequence numbers in chronological order, and then stored in the MJNL VOL1551. When storing, the latest journal data in the MJNL VOL1551 is associated with the head JNL#6611. The journal data associated with the sequence numbers from the head JNL#6611 to the MJNL purge target #6651 are regarded as accessible journal data.

The asynchronous copy function copies journal data from an MJNL VOL 551 to an RJNL VOL1552 using the asynchronous copy MJNL control program PG1221 and the asynchronous copy RJNL control program PG1222. Journal data and associated sequence numbers in MJNL VOL 551 are the same as those in the RJNL VOL1552. The asynchronous copy RJNL control program PG1222 retrieves the journal data, which does not exist in the RJNL VOL1552, from JNL VOL1552 at a set time. One of the sequence numbers from a head JNL#6611 to an RJNL copied #6722 is designated as an RJNL to-be-copied #6712; the RJNL to-be-copied #6212 is journal data that is a copy target for being copied to the RJNL VOL1552 side. Of the sequence numbers of journal data that has been promoted to the S-VOL1502, the latest (the largest) number is set to be an SVOL promoted #6742 (5222). When the S-VOL promoted #6742 is updated, the asynchronous copy RJNL control program PG1222 reports the updated SVOL promoted #6742 to the JNL common control program PG1232.

In the CDP function, first at the local end, the CDP JNL control program PG1211 sets a BVOL to-be-promoted #6631 as a target for promotes, and a BVOL promoted #6641 as the journal data that has been promoted. When the BVOL promoted #6641 is promoted, the CDP JNL control program PG1211 reports the promoted BVOL promoted #6641 to the JNL common control program PG1231. At the remote end, the CDP JNL control program PG1212 sets a BVOL to-be-promoted #6832 as a target for promoting, and BVOL promoted #6842 as the journal data that has been promoted. When the BVOL promoted #6842 is promoted, the CDP JNL control program PG1212 reports the promoted BVOL promoted #6842 to the JNL common control program PG1232.

The JNL common control program PG1232 specifies, after receiving the report or at a set time, the earliest sequence number from among the reported promoted #s. If the aforementioned earliest sequence number is later (the number is larger) than an RJNL to-be-purged #6752, the aforementioned earliest sequence number is set to be the RJNL to-be-purged #6752. If any change is made in the settings, the JNL common control program PG1232 reports the RJNL to-be-purged #6752 to the JNL common control program PG1231, and performs purging at a set time.

The JNL common control program PG1231 specifies, after receiving the report or at a set time, the earliest sequence number from among the reported promoted #s. If the aforementioned earliest sequence number is later (the number is larger) than an MJNL purge target #6651, the aforementioned earliest sequence number is set to be the MJNL purge target #6651.

According to this third embodiment, when performing journal volume-sharing both at a local site end and at a remote site end, the same advantageous effect as that of the first embodiment can be achieved.

### Other Embodiments

In the above-described first embodiment, the invention has been described for the situation where the invention is provided in the storage system 1, which is provided with: the storage array 1001 connecting to the host computers 2201, 2202 via the storage network 3001, and the storage array 1002 connected to the storage array 1001 via the storage network 3001; the P-VOL1501 for writing data sent from the host computer 2201,2202, the P-VOL1501 being included in the storage array 1001; the MJNL VOL1531 for writing data stored in the P-VOL1501 as journal data, identifiable and in chronological order, the MJNL VOL1531 being included in the storage array 1001; the base VOL1511 holding previous data, the base VOL1511 being included in the storage array 1001; the CDP JNL control program PG1211 that recovers the P-VOL1501 by providing journal data to the base VOL1511; the RJNL VOL1532 for storing the journal data of the MJNL VOL1531 in the storage array 1002, the RJNL VOL1532 being included in the storage array 1002; the S-VOL1502, which is a replication of the P-VOL1501, the S-VOL1502 being included in the storage array 1002; the asynchronous copy MJNL control program PG1221 and the asynchronous copy RJNL control program PG1222 that retrieve journal data from the MJNL VOL1531, provide the journal data of the RJNL VOL1532 to the S-VOL1502, thereby synchronizing it with the data of the P-VOL1501; and the JNL common control program PG1231 designating, from among the journal data stored in the MJNL VOL1531, journal data that is provided to both the base VOL1511 and the S-VOL1502 as a target for deletion or overwriting. However, it should be understood that the invention is not limited to these embodiments.

Also, in the above-described second embodiment, the invention has been described for the situation where the invention is provided in the storage system 2, which is provided with: the storage array 1011 and the storage array 1012; the P-VOL1501 for writing data sent from the host computer 2201,2202, the P-VOL1501 being included in the storage array 1011; the MJNL VOL1541 for writing data stored in the P-VOL1501 as journal data, identifiable and in chronological order, the MJNL VOL1541 being included in the storage array 1011; the RJNL VOL1542 for storing the journal data of the MJNL VOL1541, the RJNL VOL1542 being included in the storage array 1012; the S-VOL1502, which is a replica of the P-VOL1501, the S-VOL1502 being included in the storage array 1012; the asynchronous copy MJNL control program PG1221 and the asynchronous copy RJNL control program PG1222 that retrieve journal data from the MJNL VOL1541, provide the journal data of the RJNL VOL1542 to the S-VOL1502, thereby synchronizing it with the data of the P-VOL1501; the base VOL1512 holding previous data, the base VOL1512 being included in the storage array 1012; the CDP JNL control program PG1212 that recovers the P-VOL1501 by providing the journal data of the RJNL VOL1542 to the base VOL1512; and the JNL common control program PG1232 designating, from among the journal data stored in the RJNL VOL1542, journal data that is provided to both the S-VOL1502 and the base VOL1512 as a target for deletion or overwriting. However, it should be understood that the present invention is not limited to these embodiments.

Furthermore, in the above-described third embodiment, the invention has been described for the situation where the invention is provided in the storage system 2, which is provided with: the storage array 1021 connecting to the host computers 2201, 2202 via the storage network 3001, and the storage array 1022 connected to the storage array 1021 via the storage network 3001; the P-VOL1501 for writing data sent from the host computer 2201,2202, the P-VOL1501 being included in the storage array 1021; the MJNL VOL1551 for writing data stored in the P-VOL1501 as journal data, identifiable and in chronological order, the MJNL VOL1551 being included in the storage array 1021; the base VOL1511 holding the previous data in the storage array 1021, the base VOL1511 being included in the storage array 1021; the CDP JNL control program PG1211 that recovers the P-VOL1501 by providing journal data to the base VOL1511; the RJNL VOL1552 for storing the journal data of the MJNL VOL1551 in the storage array 1022, the RJNL VOL1552 being included in the storage array 1022; the S-VOL1502 which is a replica of the P-VOL1501, the S-VOL1502 being included in the storage array 1022; the asynchronous copy MJNL control program PG1221 and the asynchronous copy RJNL control program PG1222 that retrieve journal data from the MJNL VOL1551, apply the journal data of the RJNL VOL1552 to the S-VOL1502, thereby synchronizing it with the data of the P-VOL1501; the base VOL1512 holding previous data in the storage array 1022, the base VOL1512 being included in the storage array 1022; and the JNL common control program PG1231 designating, from among the journal data stored in the MJNL VOL1551, journal data that is provided to both the base VOL1511 and the S-VOL1502 as a target for deletion or overwriting. However, it should be understood that the present invention is not limited to these embodiments.

The present invention can be broadly provided in storage systems.

What is claimed is:

1. A storage system including a first storage system connected to a host via a communication channel, and a second storage system connected to the first storage system via a communication channel, comprising:
a first data volume for writing data sent from the host, wherein the first data volume is included in the first storage system;
a first journal volume for writing the data stored in the first data volume as journal data, identifiable and in chronological order, wherein the first journal volume is included in the first storage system;
a second data volume keeping previous data, wherein the second data volume is included in the first storage system;
a first storage controller that recovers the first data volume by providing the journal data to the second data volume;
a second journal volume for storing the journal data of the first journal volume in the second storage system, wherein the second journal volume is included in the second storage system;
a third data volume, which is a replica of the first data volume, wherein the third data volume is included in the second storage system;
a second storage controller retrieving the journal data from the first journal volume, providing the journal data of the second journal volume to the third data volume, thereby synchronizing the data with data of the first data volume; and
a third storage controller designating, from among the journal data stored in the first journal volume, the journal data that is provided to both the second data volume and the third data volume as a target for deletion or overwriting.

2. The storage system according to claim 1, wherein,
the third storage controller compares, from among the journal data stored in the first journal volume, a sequence number provided to the second data volume with a sequence number provided to the third data volume, and designates the journal data having an earlier sequence number or an even earlier sequence number, as a target for deletion or overwriting.

3. The storage system according to claim 1, further comprising:
an available capacity monitoring unit monitoring the available capacity of the first journal volume, and reporting the availability;
an earliest journal data monitoring unit specifying a data volume from the second data volume or the third data volume, wherein the data volume is not provided with the earliest journal data, from among the journal data stored in the first journal volume, which is not a target for deletion or overwriting; and
a reason reporting unit receiving, when the available capacity runs out, a report from the available capacity monitoring unit; and reporting that a storage controller controlling a data volume, which is specified by the earliest journal data monitoring unit, is the reason.

4. The storage system according to claim 3, further comprising:
a journal controller receiving a report from the available capacity monitoring unit, and reporting to a storage controller controlling a data volume specified by the earliest journal data monitoring unit; and
a fourth storage controller receiving the report, and providing journal data to a data volume.

5. The storage system according to claim 3, further comprising:
a journal controller receiving a report from the available capacity monitoring unit, and reporting to a storage controller controlling a data volume specified by the earliest journal data monitoring unit; and
a fourth storage controller receiving the report, stopping using a journal, and designating journal data that is unnecessary as a target for deletion or overwriting.

6. The storage system according to claim 1, further comprising:
a first sequence number manager managing an association between the journal data within the first journal volume and second journal volume, and a sequence number; and
a second sequence number manager managing whether or not the sequence number and the journal data are provided to the second data volume or a third data volume.

7. A storage system including a first storage system and a second storage system, comprising:
a first data volume for writing data sent from the host, wherein the first data volume is included in the first storage system;
a first journal volume for writing the data stored in the first data volume as journal data, identifiable and in chronological order, wherein the first journal volume is included in the first storage system;
a second journal volume for storing the journal data of the first journal volume, wherein the second journal volume is included in the second storage system;
a second data volume, which is a replica of the first data volume, wherein the second data volume is included in the second storage system;
a first storage controller retrieving the journal data from the first journal volume, providing the journal data of the second journal volume to the second data volume, thereby synchronizing data with data of the first data volume;
a third data volume keeping previous data, wherein the third data volume is included in the second storage system;
a second storage controller that recovers the first data volume by providing the journal data of the second journal volume to the third data volume; and
a third storage controller designating, from among the journal data stored in the second journal volume, the journal data that is provided to both the second data volume and the third data volume as a target for deletion or overwriting.

8. The storage system according to claim 7, further comprising,
a fourth storage controller designating, from among the journal data stored in the second journal volume, the journal data that is provided to both the second data volume and the third data volume as a target for deletion or overwriting from the first journal volume.

9. The storage system according to claim 7, wherein,
the third storage controller compares, from among the journal data stored in the second journal volume, a sequence number provided to the second data volume with a sequence number provided to the third data volume, and designates the journal data having an earlier sequence number or an even earlier sequence number, as a target for deletion or overwriting.

10. The storage system according to claim 7, further comprising,
an available capacity monitoring unit monitoring the available capacity of the first journal volume or the second journal volume, and reporting the status of the availability of the journal volume;
an earliest journal data monitoring unit specifying a data volume from the second data volume or the third data volume, wherein the data volume is not provided with the earliest journal data, from among the journal data stored in the first journal volume or the second journal volume, which is not a target for deletion or overwriting; and
a reason reporting unit receiving, when the available capacity runs out, a report from the available capacity monitoring unit; and reporting that a storage controller controlling a data volume, which is specified by earliest journal data monitoring unit, is the reason.

11. The storage system according to claim 10, further comprising:
a journal controller receiving a report from the available capacity monitoring unit, and reporting to a storage controller controlling a data volume specified by the earliest journal data monitoring unit; and
a fourth storage controller that receives the report, and providing journal data to a data volume.

12. The storage system according to claim 10, further comprising:
a journal controller receiving a report from the available capacity monitoring unit, and reporting to a storage controller controlling a data volume specified by the earliest journal data monitoring unit; and
a fourth storage controller receiving the report, stops using a journal, and designating journal data that is unnecessary as a target for deletion or overwriting.

13. The storage system according to claim 7, further comprising:
a first sequence number manager managing an association between the journal data within the first journal volume and second journal volume, and a sequence number; and
a second sequence number manager managing whether or not the sequence number and the journal data are provided to the second data volume or a third data volume.

14. A storage system including a first storage system connected to a host via a communication channel, and a second storage system connected to the first storage system via a communication channel, comprising:
a first data volume for writing data sent from the host, wherein the first data volume is included in the first storage system;
a first journal volume for writing the data stored in the first data volume as journal data, identifiable and in chronological order, wherein the first journal volume is included in the first storage system;
a second data volume keeping previous data in the first storage system, wherein the second data volume is included in the first storage system;
a first storage controller that recovers the first data volume by providing the journal data to the second data volume;
a second journal volume for storing the journal data of the first journal volume in the second storage system, wherein the second journal volume is included in the second storage system;
a third data volume, which is a replica of the first data volume, wherein the third data volume is included in the second storage system;
a second storage controller retrieving the journal data from the first journal volume, providing the journal data of the second journal volume to the third data volume, thereby synchronizing the data with data of the first data volume;
a fourth data volume keeping previous data in the second storage system, wherein the fourth data volume is included in the second storage system;
a third storage controller that recovers the first data volume by providing the journal data of the second journal volume to the fourth data volume; and
a fourth storage controller designating, from among the journal data stored in the first journal volume, the journal data that is provided to all the second data volume, the third data volume and the fourth data volume as a target for deletion or overwriting.

15. The storage system according to claim 14, further comprising,
a fifth storage controller designating, from among the journal data stored in the second journal volume, the journal data that is provided to all the second data volume, the third data volume and the fourth data volume as a target for deletion or overwriting from the first journal volume.
